(19) United States
(12) Patent Application Publication
(10) Pub. No.: US 2025/0069375 A1
(43) Pub. Date: Feb. 27, 2025

(54) GENERATION METHOD AND ESTIMATION DEVICE

(71) Applicant: TOYOTA JIDOSHA KABUSHIKI KAISHA, Toyota-shi (JP)

(72) Inventor: Shun SATO, Aichi-gun (JP)

(73) Assignee: TOYOTA JIDOSHA KABUSHIKI KAISHA, Toyota-shi (JP)

(21) Appl. No.: 18/772,485

(22) Filed: Jul. 15, 2024

(30) Foreign Application Priority Data
Aug. 22, 2023 (JP) 2023-134863

(51) Int. Cl. G06V 10/774; G06V 10/764; G06V 10/82

(52) U.S. Cl. CPC G06V 10/774; G06V 10/764; G06V 10/82

(57) ABSTRACT

A generation method is provided for generating a trained model for acquiring a first image and a second image, first information indicating an attitude and a type of a subject of the first image, and second information indicating an attitude and a type of a subject of the second image, generating a third image in which the first image is corrected, and estimating an attitude and a type of a subject of the fourth image based on the third image, the second image, the first information, and the second information.

### CROSS-REFERENCE TO RELATED APPLICATION

This application claims priority to Japanese Patent Application No. 2023-134863 filed on Aug. 22, 2023, incorporated herein by reference in its entirety.

### BACKGROUND

### 1. Technical Field

The present disclosure relates to a generation method and an estimation device.

### 2. Description of Related Art

Hitherto, there is known a technology for estimating a type and a posture of an object using machine learning (see, for example, Japanese Unexamined Patent Application Publication No. 2018-128897 (JP 2018-128897 A)). JP 2018-128897 A provides a detection method including a first estimation step, an extraction step, a generation step, a calculation step, and a second estimation step. In the first estimation step, an inclusion region surrounding an object and a type of the object are estimated from an image region of color image data. In the extraction step, a background region other than the object is removed from the inclusion region using information on an external region of the inclusion region, and an object region surrounded by the contour of the object is extracted. In the generation step, a distance distribution image is generated by clipping the object region extracted in the extraction step in association with an image region of distance image data. In the calculation step, the position of the object is calculated using the distance distribution image generated in the generation step. In the second estimation step, the posture of the object is estimated by checking the type of the object estimated in the first estimation step and the distance distribution image generated in the generation step against a check model prepared in advance. With the technology described in JP 2018-128897 A, it is possible to detect the type, the position, and the posture of the object captured by an imaging unit with high accuracy within a practical time.

### SUMMARY

In the related art, however, there is room for improvement, for example, to appropriately estimate the type and the posture of an object using machine learning.

An object of the present disclosure is to provide a technology capable of appropriately estimating a type and a posture of an object.

A generation method according to a first aspect of the present disclosure includes:
acquiring a first image, a second image, first information indicating a posture and a type of a subject in the first image, and second information indicating a posture and a type of a subject in the second image;
generating a third image by correcting the first image; and
generating a trained model configured to estimate a posture and a type of a subject in a fourth image based on the third image, the second image, the first information, and the second information.

An estimation device according to a second aspect of the present disclosure includes:
an acquisition unit configured to acquire a fourth image; and
an estimation unit configured to estimate a posture and a type of a subject in the fourth image based on the fourth image and a trained model.

The trained model is generated based on a third image obtained by correcting a first image, a second image, first information indicating a posture and a type of a subject in the first image, and second information indicating a posture and a type of a subject in the second image.

According to one aspect, it is possible to appropriately estimate the type and the posture of the object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of an information processing device according to an embodiment;

FIG. 2 is a flowchart illustrating an example of processing of the information processing device according to the embodiment;

FIG. 3 is the figure showing an example of DB (data base) for study concerning an embodiment; and

FIG. 4 is a diagram illustrating an example of a hardware configuration of the information processing device according to the embodiment.

### DETAILED DESCRIPTION OF EMBODIMENTS

The principles of the present disclosure are described with reference to several exemplary embodiments. It should be understood that these embodiments are set forth for purposes of illustration only and that those skilled in the art will assist in understanding and practicing the disclosure without suggesting limitations on the scope of the disclosure. The disclosure described herein may be implemented in a variety of ways other than those described below.

In the following description and claims, unless otherwise defined, all technical and scientific terms used herein have the same meaning as commonly understood by one of ordinary skill in the art to which this disclosure belongs.

Hereinafter, embodiments of the present disclosure will be described with reference to the drawings.

### Configuration

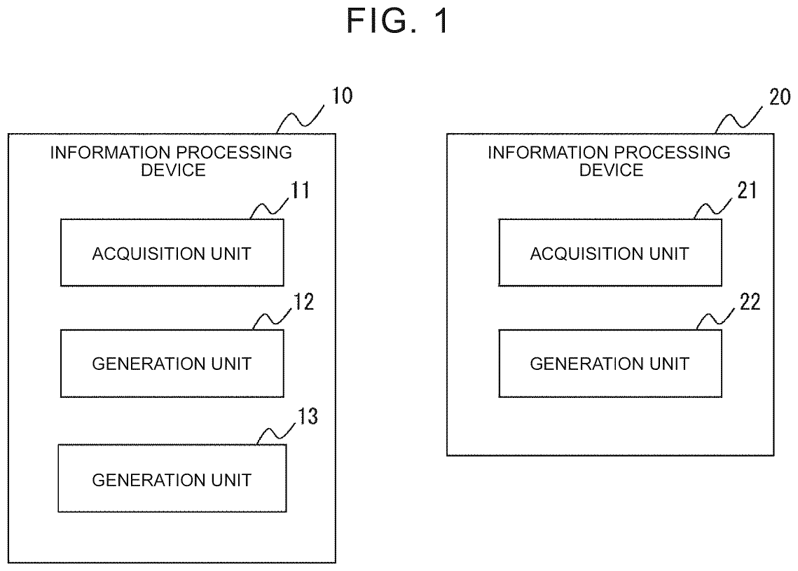

With reference to FIG. 1, a configuration of an information processing device 10 that executes a learning phase according to an embodiment and an information processing device 20 (an estimation device, a detection device, and an inference device) that executes an inference (estimation, detection) phase according to an embodiment will be described. FIG. 1 is a diagram illustrating an example of a configuration of an information processing device 10 that executes a learning phase according to an embodiment and an information processing device 20 that executes an inference phase according to an embodiment. The information processing device 10 and the information processing device 20 may be connected so as to be able to communicate with each other via a network or the like, or may be the same (integrated) device.

### Configuration of the Information Processing Device 10

In the example of FIG. 1, the information processing device 10 includes an acquisition unit 11, a generation unit 12, and a generation unit 13. These units may be realized by cooperation of one or more programs installed in the information processing device 10 and hardware such as a processor and a memory of the information processing device 10.

The acquisition unit 11 acquires a data set for machine learning. The data set for machine learning may include a plurality of pieces of data of a combination of an image captured by an image capturing device (camera) and information indicating the posture and type of each subject in the image.

The generation unit 12 generates an image obtained by correcting the image for machine learning acquired by the acquisition unit 11. The generation unit 13 performs machine learning based on at least a part of the data set for machine learning acquired by the acquisition unit 11 and the image generated by the generation unit 12. With this machine learning, the generation unit 13 generates a trained model for estimating the posture and the type of the subject of the image captured by the image capturing device.

### Configuration of the Information Processing Device 20

In the example of FIG. 1, the information processing device 20 includes an acquisition unit 21 and an estimation unit 22. These units may be realized by cooperation of one or more programs installed in the information processing device 20 and hardware such as a processor and a memory of the information processing device 20.

The acquisition unit 21 acquires an image captured by the imaging device. The estimation unit 22 estimates the posture and the type of the subject of the image based on the image and the trained model generated by the information processing device 10.

The information processing device 20 may determine, for example, whether a component such as a sensor is appropriately assembled in a factory or the like based on the estimation result of the posture and the type. Further, the information processing device 20 may pick up, for example, a component transported by a cart or the like in a factory or the like by a robot arm or the like based on the estimation result of the posture and the type.

### Processing

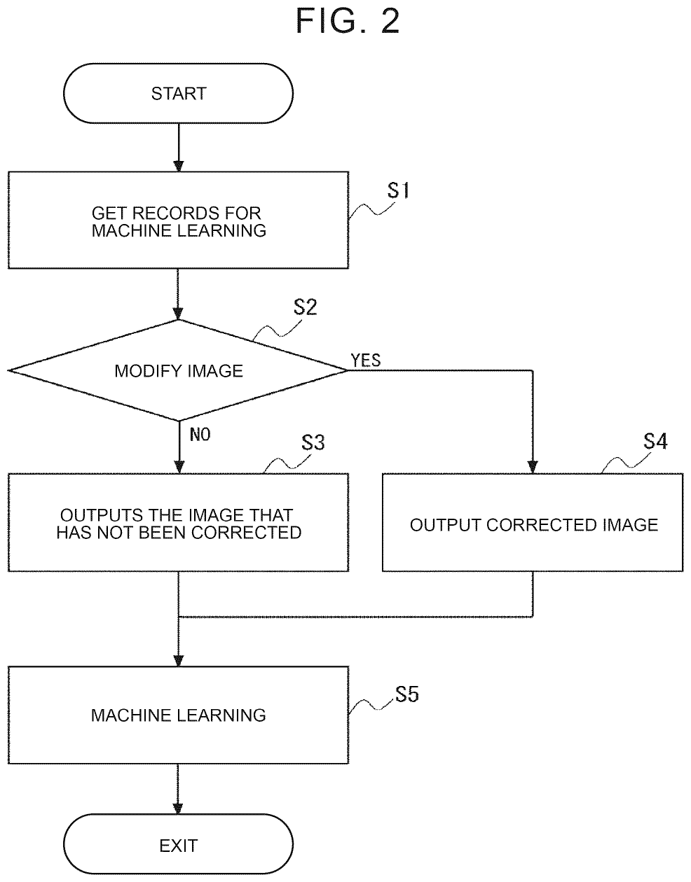

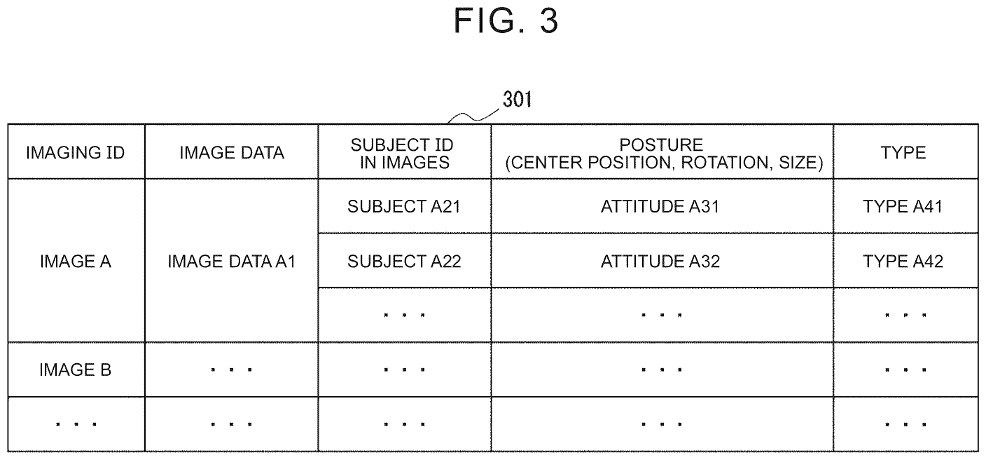

Next, an example of processing of the information processing device 10 according to the embodiment will be described with reference to FIG. 2 to FIG. 3. FIG. 2 is a flowchart illustrating an example of processing performed by the information processing device 10 according to the embodiment. FIG. 3 is a diagram illustrating an exemplary training DB (data base) 301 according to the embodiment.

The processing of FIG. 2 may be executed, for example, on a record of each learning data. The processing of FIG. 2 may be executed, for example, by the number of times specified by the user (the operator of the information processing device 10). Note that each process in FIG. 2 may be executed in a different order as long as there is no inconsistency.

In S1, the acquisition unit 11 acquires a combination (record) of data associated with one image (or image ID) included in the machine-learning data set. Here, the acquisition unit 11 may acquire, from the learning DB 301, a record that has not yet been used for learning from the machine learning dataset recorded in the learning DB 301 of FIG. 3.

Of the data sets for machine learning recorded in the learning DB 301, an image included in a record associated with one image ID is an example of a “first image”, and an image included in another record is an example of a “second image”.

In FIG. 3, an image (image data) is recorded in the learning DB 301 in association with the image ID. In addition, in association with the combination of the image ID and the subject ID in the image, information indicating the attitude (center position, revolution, size) and the type is recorded. The image ID is identification information of the image. The in-image subject ID is identification information of the respective subjects in the image.

The posture in the present disclosure is, for example, a center position, a rotation, and a size of a subject in a three-dimensional space. The posture may include, for example, information on the rotation of the subject indicated by the roll, the pitch, and the yaw. Further, the posture may include information on the center position of the subject in the three-dimensional space with respect to the imaging device and the size of the subject in the three-dimensional space. The type is a type of a subject. The type may be, for example, a type of a component (a workpiece or a work in process) to be assembled in a factory. Note that the learning DB 301 may be recorded in a storage device inside the information processing device 10 or may be recorded in a recording device outside the information processing device 10.

The image ID and the image recorded in the learning DB 301 may be recorded in advance by a user or the like, for example. The in-image subject ID, the attitude, and the type recorded in the learning DB 301 may be recorded in advance by, for example, a user.

For example, information calculated by a AI or the like may be recorded as the information indicating ID, attitude, and type of the intra-image subject recorded in the learning DB 301. In this case, for example, the information of each item may be calculated by using a technique that takes a relatively long time to infer an attitude or the like.

Note that the acquisition unit 11 may determine whether or not the size of the image recorded in the learning DB 301 (for example, the number of vertical pixels×the number of horizontal pixels) differs from the size of the image to be inputted to the convolution Convolutional Neural Network (CNN) for machine learning. If it differs, the acquisition unit 11 may change (resize) the image recorded in the learning DB 301 to the size of the image to be inputted to CNN and acquire the image.

Subsequently, the generation unit 12 determines whether or not to correct the images acquired by the acquisition unit 11 (S2). Here, the generation unit 12 may determine whether to correct the image acquired by the acquisition unit 11, for example, based on the generated random number or the like (randomly). In this case, for example, the generation unit 12 may randomly determine whether or not to correct the image so that the correction ratio of the image is approximately a specific ratio. Thus, for example, it is possible to cause the same convolutional neural network to perform learning more adapted to both the posture estimation and the type estimation of the subject. The specific ratio may be set in advance by a user of the information processing device 10 or the like.

When it is determined that the image is not to be corrected (NO in S2), the generation unit 12 outputs the image acquired by the acquisition unit 11 and not corrected to the generation unit 13 as an image for training (S3), and proceeds to S5 process.

On the other hand, when it is determined that the image is to be corrected (YES in S2), the generation unit 12 outputs the image obtained by correcting the image (the “first image”) (the “third image”) acquired by the acquisition unit 11 to the generation unit 13 as an image for training (S4). Here, for example, the generation unit 12 may generate a third image in which at least one of a value indicating a color (for example, a RGB value), a brightness, a saturation, and a hue of each pixel of the first image is changed.

In this case, for example, the generation unit 12 may generate a third image in which each pixel value of the first image is changed so that each value of the average value and the standard deviation becomes a specific value. As a result, compared with the first image, a third image in which the color of the object is changed but the outline of the object is clarified is generated. As a result, for example, the estimation of the type of the object can be performed with higher accuracy even for an image with a strong shadow or the like. Further, for example, the estimation of the type of the object can be performed with higher accuracy even for an object that is close to transparent or an object that is close to the color of a background object.

Note that, for example, the generation unit 12 may randomly determine the average value and the standard deviation based on a random number or the like. Note that the value indicating the color of the pixel may be, for example, a value of RGB (Red, Green, Blue). The brightness of the pixel may be calculated by, for example, a 0.3 R+0.6 G+0.1 B or the like.

Further, the generation unit 12 may average each pixel value of the first image with a pixel width determined at random or the like, for example. As a result, for example, it is possible to learn even an image in which the outline of the object is unclear. Therefore, for example, in the information processing device 20, even when the size (the number of pixels) of an image captured by the imaging device at the time of estimation of the posture or the like is relatively small, it is possible to estimate the image with higher accuracy. Further, the generation unit 12 may change (process) each pixel value of the first image with, for example, the intensity of the motion blur determined at random or the like. Thus, for example, in the information processing device 20, even when the blur caused by the vibration or the like of the image captured by the imaging device at the time of estimation of the posture or the like is relatively large, it is possible to estimate the image with higher accuracy.

Subsequently, the generation unit 13 performs machine learning using the same convolutional neural network on the basis of the image outputted by the generation unit 12 and the information indicating the attitude and the type corresponding to the subject ID in the respective images included in the record acquired by the acquisition unit 11 (S5). Here, the generation unit 13 may use, for example, Residual Network (ResNet), EfficientNet, DenseNet, or FastR-CNN as the convolutional neural network. Here, the generation unit 13 may use the image as training data and learn the posture and the type of one or more subjects as correct answer labels. Accordingly, a trained model is generated that estimates the posture and the type of each subject in the fourth image using the same convolutional neural network based on the fourth image captured by the image capturing device.

In addition, this makes it possible to estimate (recognize) the attitude and type of a plurality of subjects (objects) based on a single image without performing crop of the image, for example. Therefore, the calculation amount can be reduced as compared with a technique of performing an estimation based on the cut-out image after performing a process of cutting out the region of the subject in the image. Other

For example, it is conceivable to machine-learn the posture and type of an object based on an image obtained by performing a color conversion process in order to further clarify a color boundary. In this case, since the color (hue) of the object cannot be learned, there is a possibility that the accuracy of estimating the type of the object is deteriorated for an object having a different color from that at the time of machine learning.

In addition, when machine-learning the attitude and type of an object with an image of the original color flavor that has not converted the color conversion process, the accuracy of estimation of the attitude of the object may be reduced if the outline of the object is unclear due to shadows or blurrs. In addition, in a method of extracting an area in which a subject is imaged and a method of calculating Region of Interest (ROI) when the types of a plurality of objects are estimated from one image, the time required for the estimation process increases due to an increase in computational complexity.

Further, for example, in the case of the attitude estimation method based on 3D modeling, even if the accuracy of the estimation of the attitude can be improved, the time required for the estimation process increases due to the increase in the computational complexity. In addition, in an actual site, there is a case where noise gets on the point cloud data itself due to the influence of the occlusion problem or the disturbance, and thus the accuracy is lowered. On the other hand, in the present disclosure, a case of learning based on an image in which a color tone is corrected and a case of learning based on an image in which a color tone is not corrected are caused. This makes it possible to appropriately estimate the type and orientation of the object by using machine learning.

### Hardware Configuration

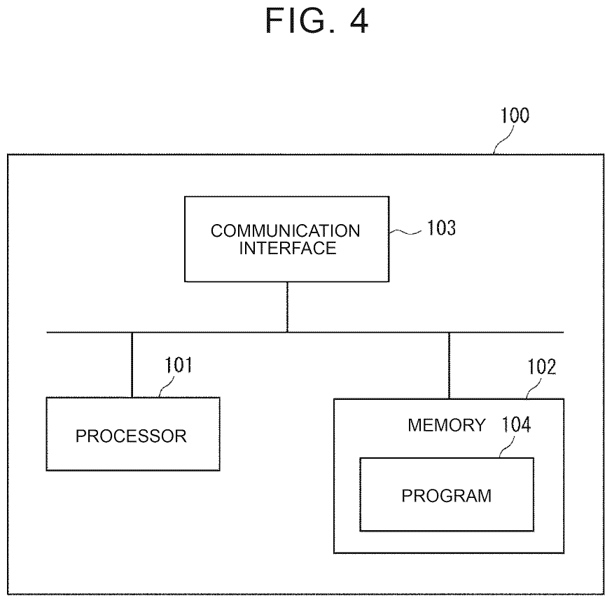

FIG. 4 is a diagram illustrating an example of a hardware configuration of each of the information processing devices 10 and 20 according to the embodiment. In the example of FIG. 4, the information processing devices 10 and 20 (the computer 100) include a processor 101, a memory 102, and a communication interface 103. These units may be connected by a bus or the like. The memory 102 stores at least a part of the program 104. The communication interface 103 includes an interface necessary for communication with other network elements.

When the program 104 is executed by the cooperation of the processor 101 and the memory 102, the computer 100 performs processing of at least a part of the embodiments of the present disclosure. The memory 102 may be of any type. Memory 102 may be, by way of non-limiting example, a non-transitory computer-readable storage medium. Memory 102 may also be implemented using any suitable data storage technology, such as semiconductor-based memory devices, magnetic memory devices and systems, optical memory devices and systems, fixed and removable memory, and the like. Although only one memory 102 is shown in computer 100, there may be several physically different memory modules in computer 100. The processor 101 may be of any type. The processor 101 may include one or more of a general purpose computer, a special purpose computer, a microprocessor, a Digital Signal Processor (DSP), and as non-limiting examples, a processor based on a multi-core processor architecture. The computer 100 may comprise a plurality of processors, such as application specific integrated circuit chips, which are temporally dependent on the clock that synchronizes the main processor.

Embodiments of the present disclosure may be implemented in hardware or dedicated circuitry, software, logic, or any combination thereof. Some aspects may be implemented in hardware, while other aspects may be implemented in firmware or software that may be executed by a controller, microprocessor, or other computing device.

The present disclosure also provides at least one computer program product tangibly stored on a non-transitory computer readable storage medium. The computer program product includes computer-executable instructions, such as instructions contained in a program module, executed on a device on a real or virtual processor of interest to perform the processes or methods of the present disclosure. Program modules include routines, programs, libraries, objects, classes, components, data structures, etc. that perform particular tasks or implement particular abstract data types. The functionality of the program modules may be combined or split between the program modules as desired in various embodiments. The machine-executable instructions of the program modules may be executed in a local or distributed device. In a distributed device, program modules can be located on both local and remote storage media.

Program code for performing the methods of the present disclosure may be written in any combination of one or more programming languages. These program codes are provided to a processor or controller of a general purpose computer, special purpose computer, or other programmable data processing device. When program code is executed by a processor or controller, functions/operations in the flowcharts and/or implementing block diagrams are performed. The program code is executed entirely on the machine, partly on the machine, as a stand-alone software package, partly on the machine, partly on the remote machine, or entirely on the remote machine or server.

The program can be stored using various types of non-transitory computer readable media and supplied to a computer. Non-transitory computer-readable media include various types of tangible recording media. Examples of non-transitory computer-readable media include magnetic recording media, magneto-optical recording media, optical disk media, semiconductor memory, and the like. Examples of the magnetic recording medium include a flexible disk, a magnetic tape, and a hard disk drive. The magneto-optical recording medium includes, for example, a magneto-optical disk. Optical disc media include, for example, Blu-ray discs, CD (Compact Disc)-ROM (Read Only Memory), CD-R (Recordable), CD-RW (Re Writable), etc. Semiconductor memories include, for example, solid-state drives, mask ROM, PROM (Programmable ROM), EPROM (Erasable PROM), flash ROM, RAM (random access memory), etc. The program may also be supplied to the computer by various types of transitory computer readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

### Modification

The information processing devices 10 and 20 may be devices included in one housing, but the information processing devices 10 and 20 of the present disclosure are not limited thereto. The respective units of the information processing devices 10 and 20 may be realized by cloud computing constituted by one or more computers, for example.

The present disclosure is not limited to the above embodiments, and can be appropriately modified without departing from the spirit thereof.

What is claimed is:

1. A generation method comprising:
acquiring a first image, a second image, first information indicating a posture and a type of a subject in the first image, and second information indicating a posture and a type of a subject in the second image;
generating a third image by correcting the first image; and
generating a trained model configured to estimate a posture and a type of a subject in a fourth image based on the third image, the second image, the first information, and the second information.

2. The generation method according to claim 1, further comprising generating the third image by changing an average value and a standard deviation of at least one of a value indicating a color, a brightness, a saturation, and a hue of each pixel of the first image.

3. The generation method according to claim 1, further comprising randomly determining which of the first image and the third image is used to generate the trained model.

4. The generation method according to claim 1, further comprising generating a trained model configured to estimate the posture and the type of the subject in the fourth image using the same convolutional neural network based on the third image, the second image, the first information, and the second information.

5. An estimation device comprising:
an acquisition unit configured to acquire a fourth image; and
an estimation unit configured to estimate a posture and a type of a subject in the fourth image based on the fourth image and a trained model, wherein the trained model is generated based on a third image obtained by correcting a first image, a second image, first information indicating a posture and a type of a subject in the first image, and second information indicating a posture and a type of a subject in the second image.
